(19) United States
(12) Patent Application Publication
(10) Pub. No.: US 2026/0052340 A1
(43) Pub. Date: Feb. 19, 2026

(54) RADIO DONGLE MODULAR ACCESSORY

(71) Applicant: MOTOROLA SOLUTIONS, INC., Chicago, IL (US)

(72) Inventors: Haim Kahlon, Shoham (IL); Lionid Kodner, Modiin-Maccabim Reut (IL); Shuki Levy, Rishon LeZion (IL); Yaakov Margaliot, Petach Tikwa (IL); Hadi Shvartz, Ashkelon (IL)

(21) Appl. No.: 18/808,514

(22) Filed: Aug. 19, 2024

(51) Int. Cl. H04R 3/00; H01R 12/52; H01R 31/06

(52) U.S. Cl. CPC H04R 3/00; H01R 12/52; H01R 31/06; H04R 2420/07

(57) ABSTRACT

A dongle for use with an electronic communications device having an accessory port. The dongle including a body, a first connection port coupled to the body and configured to establish a first plurality of electrical connections with the accessory port of the electronic communications device, a second connection port coupled to the body and configured to establish a second plurality of electrical connections with another electrical device, and a wireless communication assembly. Where the wireless communication assembly is configured to receive a first signal from the second connection port and generate wireless signals, and where the dongle is configured to pass through a second signal between the first connection port and the second connection port.

### BACKGROUND

Some hand-held two-way radios are limited to communicating wirelessly according to land mobile radio (LMR) protocols. These same radios often include an accessory port that supports a remote speaker microphone (RSM) or other accessory.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments, examples, aspects, and features of concepts that include the claimed subject matter, and to explain various principles and advantages of those embodiments, examples, aspects, and features.

FIG. 1 is a front exploded view of a wireless electronic communication device, a radio dongle, and a remote speaker microphone (RSM) according to one example.

FIG. 2 is a front view of the connection port of the RSM of FIG. 1 attached to the accessory port of the wireless electronic communication device of FIG. 1.

FIG. 3 is a front view of the radio dongle of FIG. 1 attached to the accessory port of the wireless electronic communication device of FIG. 1.

FIG. 4 is a front view of the radio dongle of FIG. 1 attached to the accessory port of the wireless electronic communication device of FIG. 1 and the RSM of FIG. 1 attached to the radio dongle of FIG. 1.

FIG. 5 is a perspective exploded view of the wireless electronic communication device, radio dongle, and RSM of FIG. 1.

FIG. 6 is a front perspective view of the radio dongle of FIG. 1 where the body of the radio dongle is illustrated as translucent to permit visualization of components within the dongle.

FIG. 7 is a rear perspective view of the radio dongle of FIG. 6.

FIG. 8 is a section view take along line 8-8 of FIG. 6.

FIG. 9 is a schematic view of the radio dongle of FIG. 1 attached to the wireless communication device and RSM of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help improve understanding of the examples, aspects, and features presented in this disclosure.

The system, apparatus, and method components have been represented where appropriate by conventional symbols in the drawings, showing only those specific details that are pertinent to understanding of the various embodiments, examples, aspects, and features of the present disclosure so as not to obscure the disclosure with details that will be readily apparent to those of ordinary skill in the art having the benefit of the description herein.

### DETAILED DESCRIPTION OF THE INVENTION

As mentioned, some wireless electronic communication devices, such as two-way radios, are limited to communicating wirelessly according to land mobile radio (LMR) protocols. Such wireless electronic communication devices also generally have a limited number of accessory ports for external accessories to be attached. The inventors have identified the need to expand the wireless communication capabilities of wireless electronic communication devices while maintaining the number of available accessory ports.

One example provides, a dongle for use with an electronic communications device having an accessory port, the dongle including a body, a first connection port coupled to the body and configured to establish a first plurality of electrical connections with the accessory port of the electronic communications device, a second connection port coupled to the body and configured to establish a second plurality of electrical connections with another electrical device, and a wireless communication assembly, where the wireless communication assembly is configured to receive a first signal from the second connection port and generate wireless signals, and where the dongle is configured to pass through a second signal between the first connection port and the second connection port.

Another example provides, a dongle for use with an electronic communications device having a first connection port, the dongle including a body defining a first pocket and a second pocket, and wherein the first pocket is open to the second pocket via a first channel, a first PCB positioned within the first pocket, where the first PCB includes a first plurality of connection points configured to establish electrical connections with the first connection port of the electronic communications device, a second PCB positioned within the second pocket, where the second PCB includes a second plurality of connection points configured to establish electrical connections with another electrical device, and where the second PCB is coupled to the first PCB via the first channel, a wireless communications assembly in operable communication with at least one of the first PCB and the second PCB, and an antenna coupled to the body, where the antenna is connected to one of the first PCB and the second PCB via an electrical connection extending through a second channel defined by the body.

Another example provides, a portable communication system including a wireless communication device including a first connection port with a power supply connection, a second connection port without a power supply connection, and a first wireless communication assembly. The portable communication system also including a dongle including a third connection port configured to connect to the second connection port of the wireless communication device, a fourth connection port, and a second wireless communication assembly receiving a first signal via the third connection port, and where a second signal is passed through between the third connection port and the fourth connection port, and an accessory having a fifth connection port configured to attach to either the second connection port of the wireless communication device or the fourth connection port of the dongle.

Each of the above-mentioned examples will be discussed in more detail below, starting with example system and device architectures of the system in which the examples may be practiced, followed by an illustration of processing blocks for achieving an improved technical method, device, and system for a push-to-talk button assembly for use on an electronic communications device.

Further advantages and features consistent with this disclosure will be set forth in the following detailed description, with reference to the figures.

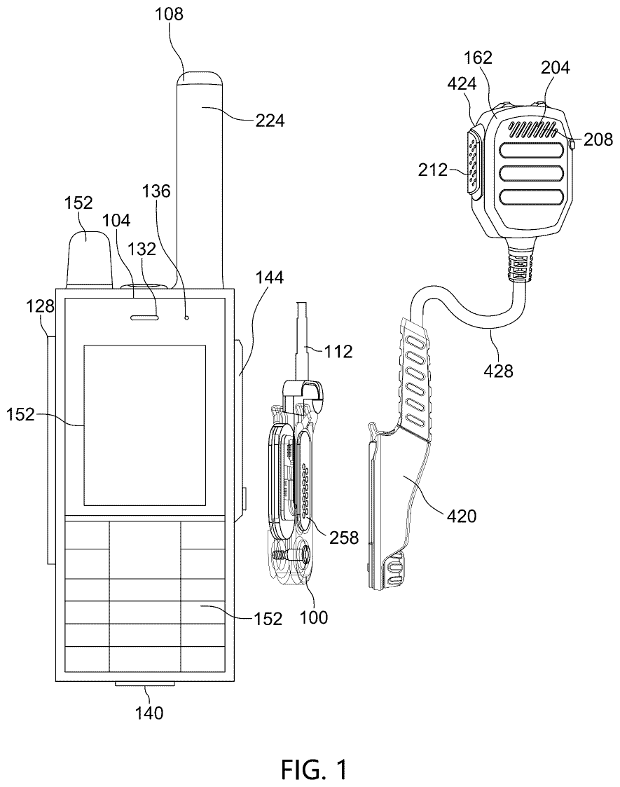

FIG. 1 illustrates an example of a radio dongle 100 for use with a wireless electronic communication device 104. In the example, shown the dongle 100 is part of a portable communication system that includes a dongle 100, the device 104, and an accessory (explained below). In the example shown, the radio dongle 100 includes a wireless communication assembly 112. During use, the dongle 100 is configured to be coupled to an accessory port 144 of the electronic communication device 104 and expand the wireless capabilities of the device 104 by sending and receiving wireless signals using a wireless communication standard that is different than the wireless communication standard used by the device 104 itself. The dongle 100 also includes an accessory port (e.g., the second dongle connection port 258) that at least partially replicates the capabilities of the device's accessory port 144 so that additional accessories (e.g., a remote speaker microphone or RSM 162) may be attached to the device 104 even when the dongle 100 is installed and in operation.

In the example shown in FIGS. 1-5, the electronic communication device 104 includes a hand-held two-way radio. The device 104 includes a housing 128, a speaker 132 mounted within the housing 128, a microphone 136 mounted within the housing 128, a first connection port or docking port 140, a second connection port or accessory port 144, and a first wireless communication assembly 108. In some examples, the device 104 may also include one or more user interfaces 152 such as a push-to-talk button, keypad, touchscreen, screen, and the like to allow the user to operate and receive information from the device 104 during use.

The docking port 140 of the electronic communication device 104 is configured to form a connection with a dock, charging cable, data cable, and the like. The docking port 140 includes a plurality of electrical contacts or pins (not shown), each configured to form an electrical connection with the attached device to transmit electrical power and/or data signals therethrough. In the illustrated example, the docking port 140 also includes a power supply connection configured to transmit electrical power for charging the internal batteries of the device 104.

The docking port 140 defines a first connection layout. The first connection layout consists of the size, shape, and position of the electrical contacts within the docking port 140. In the example shown, the first connection layout may include, but is not limited to, a male or female universal serial bus connection (USB), a proprietary connection, and the like. However, in other embodiments the first connection layout may include other types and layouts of electrical connections.

The accessory port 144 of the electronic communication device 104 is configured to be releasably coupled to an accessory (e.g., a remote speaker microphone (RSM) 162), and the like) and transmit electrical signals therebetween. In some examples, the accessory port 144 includes a plurality of electrical connection points or pins 164, each capable of forming an electrical connection with the attached accessory. In the illustrated example, the accessory port 144 does not include a power supply connection to transmit electrical power for charging the internal batteries of the device 104. However, in other examples the accessory port 144 may include a power supply connection.

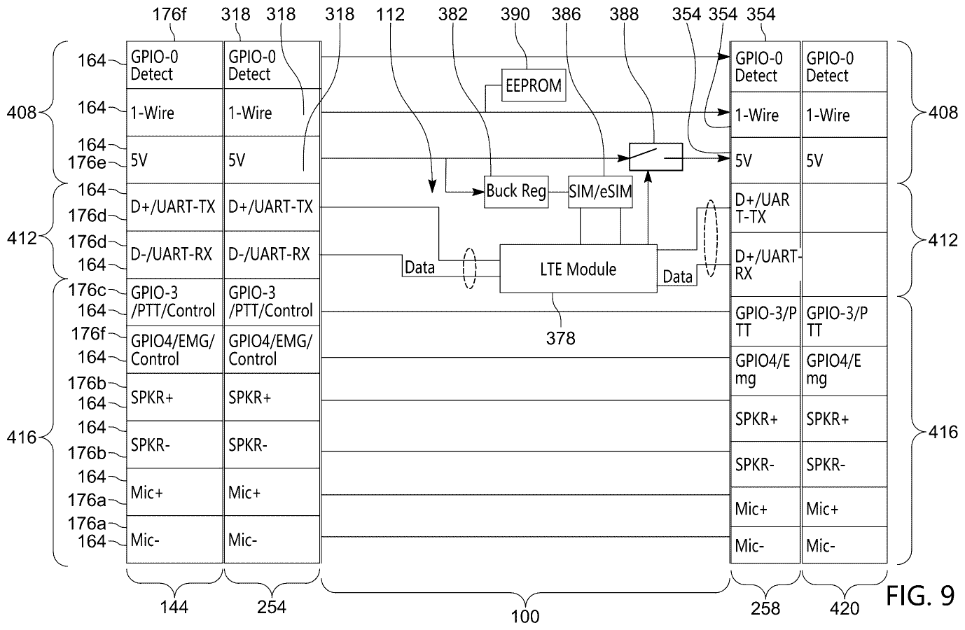

With reference to FIG. 9, the connection points 164 of the accessory port 144 are configured to transmit a plurality of signals therethrough. In the illustrated example, the connection points 164 are configured to support the transmission of a remote microphone signal 176a, a remote speaker signal 176b, a remote push-to-talk (PTT) control signal 176c, data signals 176d, a constant voltage source (e.g., a 5 V source) 176e, and one or more general purpose input/output (GPIO) signals 176f. It is understood that in other examples, more or fewer connection points 164 may be present in the accessory port 144 to support more or fewer signals or connections. For example, in some examples a common ground may be present.

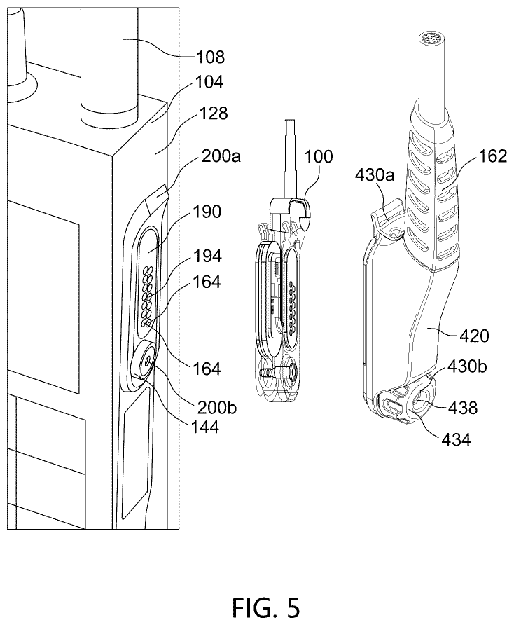

With reference to FIG. 5, the accessory port 144 includes a connection interface 190 on which one or more metallic disks 194 are positioned in a pre-determined pattern. Each disk 194 serves as a corresponding connection point 164 and is configured to form an electrical connection with a corresponding pogo pin 326 (discussed below) of the attached accessory. In some examples, the disks 194 are arranged in a pair of offset rows. However, in other examples, different layouts may be used. While the illustrated port 144 includes disks to be used with corresponding pogo pins, it is understood that in other examples other forms of connection points may be used.

The accessory port 144 also includes two attachment points 200a, 200b positioned on opposite sides of the connection interface 190. Each attachment point 200a, 200b is configured to form a physical connection with the accessory coupled to the accessory port 144 (e.g., the dongle 100, the RSM 162, or another accessory). In one example, the first attachment point 200a includes a recess formed into the housing 128. In other examples the first attachment point 200a may include a protrusion. In still other examples, other forms of connection may be used.

The second attachment point 200b includes a set of female threads formed into the housing 128 that are configured to receive a corresponding set of male threads therein. While a female-type connection is shown, it is understood that in other examples a male-type connection may be used. In still other examples, other forms connection may be used, for example, a bayonet connection, detents, locking pawls, and the like.

As shown in FIG. 5, the accessory port 144 defines a second connection layout, different than the first connection layout of the docking port 140. The second connection layout consists of the size, shape, and position of the electrical connection points 164 and the size, shape, and position of the attachment points 200a, 200b included in the port 144. In the illustrated example, the second connection layout is a female mini global core accessory interface (mini-GCAI). However, in other examples, the second connection layout may include a male mini-GCAI. In still other examples, the second connection layout may include other connection styles such as, but not limited to, female GCAI, and male GCAI. The GCAI and mini-GCAI layouts were developed by Motorola. In still other examples, other forms of connection layout may be used that are not GCAI or mini-GCAI layouts.

As shown in FIG. 1, the first wireless communication assembly 108 of the electronic communication device 104 includes an antenna 224 and is configured to send and receive wireless signals using a first wireless communication standard. In some examples, the first wireless communication assembly 108 serves as both a transmitter and receiver sending and receiving radio signals at a predetermined frequency according to a land mobile radio (LMR) protocol. While the illustrated first wireless communication assembly 108 operates using an LMR protocol, it is understood that in other examples other wireless communications protocols or standards may be used.

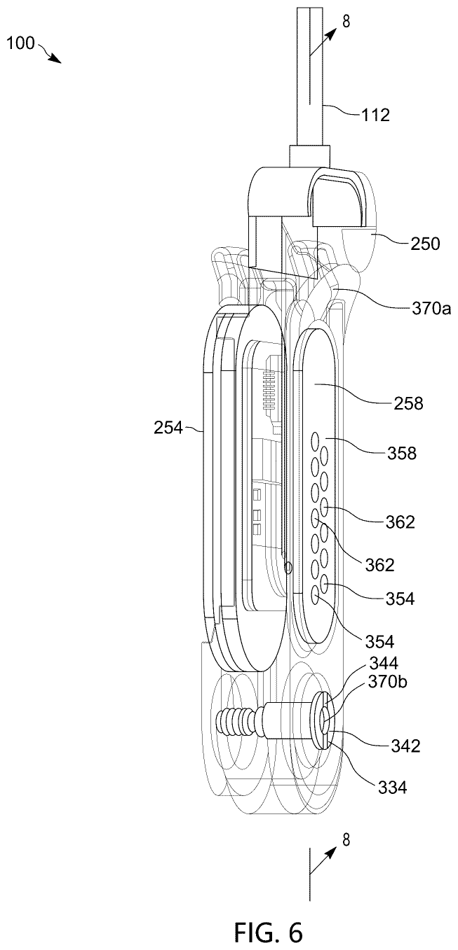

As shown in FIGS. 6-8, the dongle 100 includes a body 250, a first dongle connection port 254, a second dongle connection port 258, and a second or dongle wireless communication assembly 112. During use, the dongle 100 is configured to be coupled to the device 104 (e.g., the first dongle connection port 254 is coupled to the accessory port 144) such that a plurality of signals is exchanged via the resulting connection.

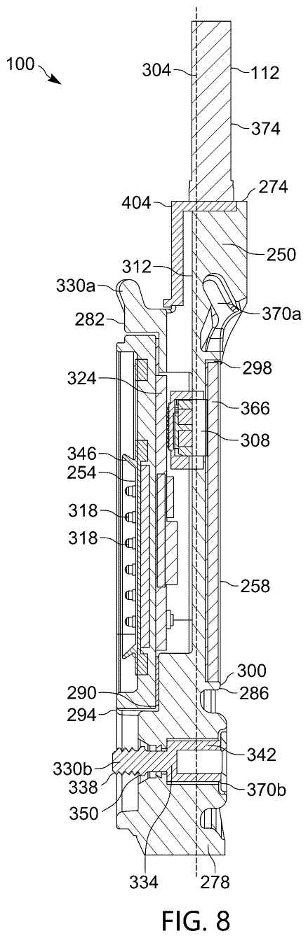

As shown in FIG. 8, the body 250 of the dongle 100 is formed from a single piece of material (e.g., metal) and includes a first end 274, a second end 278 opposite the first end 274, a first surface 282 positioned between the first end 274 and the second end 278, and a second surface 286 positioned between the first end 274 and the second end 278. In the illustrated example, the first surface 282 is opposite the second surface 286 such that the first surface 282 is parallel to and faces away from the second surface 286.

The body 250 also defines a first pocket 290 formed into the first surface 282 to define a first opening 294, and a second pocket 298 formed into the second surface 286 to form a second opening 300. As shown in FIG. 8, the first opening 294 faces opposite the second opening 300. In some examples, a first reference plane 304 longitudinally extends through the body 250 (e.g., extends through the first end 274 and the second end 278) such that the first pocket 290 and the second pocket 298 are completely positioned on opposite sides thereof.

The body 250 also defines a first channel 308 extending between and open to both the first pocket 290 and the second pocket 298. In the illustrated example, the first channel 308 is oriented normal to the first reference plane 304. The body 250 also defines a second channel 312 open at one end to the exterior of the body 250 (e.g., proximate the first end 274) and intersecting one of the first pocket 290, the second pocket 298, and the first channel 308. In the illustrated example, the second channel 312 is oriented parallel to the first reference plane 304 and perpendicular to the first channel 308.

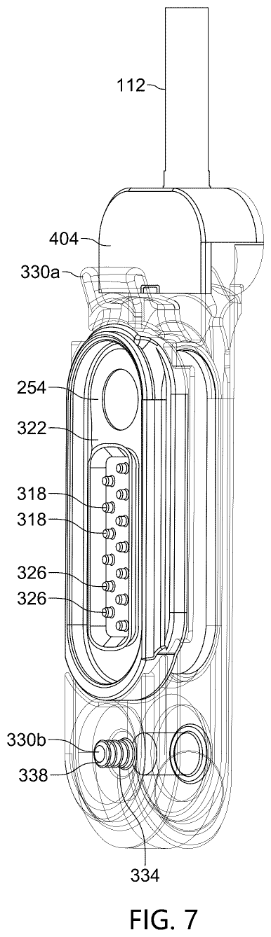

As shown in FIGS. 7 and 8, the first dongle connection port 254 is configured to be releasably couplable to the accessory port 144 of the device 104. The first dongle connection port 254 includes a plurality of electrical connection points or pins 318, each point 318 being positioned and configured to form an electrical connection with a corresponding connection point 164 of the accessory port 144 when coupled thereto. As shown in FIG. 9, the connection points 318 of the first dongle connection port 254 are configured to support the transmission of a plurality of signals therethrough. In the illustrated example, the connection points 318 are configured to support the transmission of at least a portion of the plurality of signals supported by the accessory port 144 of the device 104 (discussed above). While the layout of the illustrated connection points 318 are the same as the layout of the connection points 164 of the device 104, it is understood that in other examples only a portion of the connection points may align. In some examples the dongle 100 may have additional connection points, while in other examples the device 104 may have additional connection points. In still other examples, both the dongle 100 and the device 104 may have connection points that are not paired.

The first dongle connection port 254 includes a connection interface 322 on which one or more pogo pins 326 are positioned in a pre-determined pattern. During use, each pogo pin 326 serves as a corresponding connection point 318 and is configured to form a discrete electrical connection with a corresponding disk 194 of the accessory port 144 when coupled thereto. In the illustrated example, the pogo pins 326 are spring-loaded metallic protrusions that compress or otherwise retract when placed in direct contact with the disks 194. While the illustrated example includes pogo pins 326, it is understood that in other examples other forms of electrical connection may be used.

As shown in FIG. 8, the connection interface 322 of the first dongle connection port 254 is formed by a first printed circuit board (PCB) 324 with the connection points 318 (e.g., the pogo pins 326) and associated circuitry incorporated therein. In the illustrated example, the first PCB 324 is positioned within the first pocket 290 of the body 250 such that the connection points 318 are accessible from outside the body 250 while the associated circuitry is contained and protected within the pocket 290.

The first dongle connection port 254 also includes a gasket or flange 346. The gasket 346 is incorporated into the connection interface 322 of the first PCB 324 and is configured to interact with the connection interface 190 of the accessory port 144 to form a seal therewith to protect the connection points 164, 318 (e.g., the pogo pins 326 and disks 194) from debris and moisture.

The first dongle connection port 254 also includes two attachment points 330a, 330b positioned on opposite sides of the connection interface 322. Each attachment point 330a, 330b is configured to form a corresponding physical connection with the first and second attachment points 200a, 200b of the accessory port 144, respectively. In one example, the first attachment point 330a includes a protrusion or mounting tab 220 configured to be received within the recess of the first attachment point 200a of the accessory port 144. In other examples, the first attachment point 330a may include a recess. In still other examples, other forms of connection may be used.

The second attachment point 330b includes a fastener 334 movably coupled to the body 250 of the dongle 100. The fastener 334 includes a first end 338 serving as the second attachment point 330b of the first dongle connection port 254 (e.g., configured to form a connection with the first attachment point 200a of the accessory port 144), and a second end 342 opposite the first end 338 that is configured to form the second attachment point 370b of the second dongle connection port 258 (e.g., duplicate the second attachment point 200b of the accessory port 144; see FIGS. 6 and 8). In some examples, the first end 338 forms a first connection style that is configured to be coupled to a second connection style. In other examples, the second end may then include the second connection style to which the first end is configured to be coupled.

In the illustrated example, the first end 338 includes a male set of threads configured to form a releasable connection with the female threads of the second attachment point 200b. Furthermore, the second end 342 of the fastener 334 includes a female set of threads that mirror the female threads of the second attachment point 200b of the accessory port 144. In some examples, the male threads and the female threads may be co-axial.

As shown in FIG. 6, the fastener 334 also includes a set of grooves or slots 344 formed into the second end 342 configured to be engaged by a tool, for example, a screw-driver or the like, so that the fastener 334 rotates relative to the body 250 in response to a torque applied by the tool. While the illustrated fastener 334 includes male and female threads on both ends 338, 342 thereof, it is understood that in other examples different connection styles, such as bayonet fitting, detents, locking pawls, and the like may be used.

In the illustrated example, the fastener 334 is captured within the body 250 of the dongle 100 so that the fastener 334 may rotate freely with respect thereto but whose axial motion is limited. By doing so, the fastener 334 may rotate and axially travel as needed to threadably connect the first end 338 of the fastener 334 with the female threads of the second attachment point 200b but remains attached to the body 250 so that the fastener 334 cannot fall out and be lost. In the illustrated example, the fastener 334 includes a locking protrusion 350 proximate the first end 338 that retains the fastener 334 within the body 250.

The first dongle connection port 254 defines a third connection layout that is compatible with the second connection layout of the accessory port 144 such that the first dongle connection port 254 is couplable to the accessory port 144. The third connection layout consists of the size, shape, and position of the electrical connection points 318 and the size, shape, and position of the attachment points 330a, 330b included in the port 254. In some examples, the second connection layout and the third connection layout are corresponding male and female pairs of the same connection style. In the illustrated example, the third connection layout includes a male mini-GCAI connection to correspond with the female mini-GCAI connection of the accessory port 144. However, in other examples, the second connection layout may include a female mini-GCAI. In still other examples, the third connection layout may include other connection styles such as female GCAI, and male GCAI. In still other examples, other forms of connection layout may be used that are not GCAI or mini-GCAI layouts.

As show in FIGS. 6 and 8, the second dongle connection port 258 is configured to be releasably coupled to an accessory or other electrical device (e.g., a RSM 162, and the like) such that the accessory is in electrical communication with the device 104 and operable simultaneously with the dongle 100. Similar to the accessory port 144, the second dongle connection port 258 includes a plurality of electrical connection points or pins 354, each capable of forming an electrical connection with the attached accessory to permit the transmission of electrical signals therebetween.

As shown in FIG. 9, the connection points 354 of the second dongle connection port 258 are configured to support the transmission of a plurality of signals therethrough. In the illustrated example, the connection points 354 are configured to support the plurality of signals that are both supported by the accessory port 144 of the device 104 and that have been passed through by the dongle 100 itself (e.g., the common signals 408 and the accessory signals 416). In other examples, the second dongle connection port 258 may also support communication signals 412. In such examples, the communication signals 412 may be generated by the second wireless communication assembly 112 (e.g., the LTE module 378) or be passed through from the accessory port 144. In still other examples, the second dongle connection port 258 may support signals generated by the dongle 100 itself.

While the layout of the illustrated connection points 354 is the same as the layout of the connection points 164 of the device 104, it is understood that in other examples only a portion of the connection points may align. In some examples the accessory port 144 may have additional connection points, while in other examples the second dongle connection port 258 may have additional connection points. In still other examples, the second dongle connection port 258 may only include connection points 354 that transmit signals that are not related to operation of the second wireless communication assembly 112 (e.g., connection points 354 associated with common and accessory signals 408, 416). In still another example, the second dongle connection port 258 may include connection points 354 that transmit signals generated by the dongle 100 that are not supported by the accessory port 144. In still other examples, the second dongle connection port 258 may repurpose select connection points 354 so that they support signals different from those output by the accessory port 144 at the same position. For example, the second dongle connection port 258 may repurpose the connection points 164 that transmit communication signals 412 in the accessory port 144 so that similarly positioned connection points 354 of the second dongle connection port 258 now support common or accessory signals 408, 416.

The second dongle connection port 258 includes a connection interface 358 on which one or more metallic disks 362 are positioned in a pre-determined pattern. During use, each disk 362 serves as a corresponding connection point 354 and is configured to form an electrical connection with the accessory attached thereto. In the illustrated example, the disks 362 are arranged in a pair of offset rows (see FIG. 6), however in other examples, other layouts may be used. While the illustrated port 258 includes disks to be used with corresponding pogo pins, it is understood that in other examples other forms of connection points may be used.

As shown in FIG. 8, the connection interface 358 of the second dongle connection port 258 is formed by a second PCB 366 with the disks 362 and associated circuitry incorporated therein. In some examples, the second PCB 366 is positioned within the second pocket 298 of the body 250 such that the disks 362 are accessible from outside the body 250 while the associated circuitry is contained and protected within the pocket 298.

In some examples, the second PCB 366 may be coupled to the first PCB 324 using a board-to-board connector. In other examples, the second PCB 366 may be coupled to the first PCB 324 using individual wires, a FLEX connection, or other forms of electrical connection. Furthermore, such connections may extend through the first channel 308 between the first and second PCBs 324, 366.

The second dongle connection port 258 also includes two attachment points 370a, 370b positioned on opposite sides of the connection interface 358. Each attachment point 370a, 370b is configured to replicate the corresponding attachment points 200a, 200b of the accessory port 144. In one example, the first attachment point 370a includes a recess formed into the body 250. In other examples, the first attachment point 370a may include a protrusion. In still other examples, other forms of connection may be used.

The second attachment point 370b includes the second end 342 of the fastener 334. In the present example, the second end 342 of the fastener 334 is a set of female threads that replicate the female threads of the second attachment point 200b of the accessory port 144. However, in other examples, different forms of connection may be present such as, male threads, bayonet fitting, detents, locking pawls, and the like.

In some examples, the second dongle connection port 258 includes a fourth connection layout that is the same or compatible with the second connection layout of the accessory port 144 so that a connection port that is couplable with the accessory port 144 is also couplable with the second dongle connection port 258. The fourth connection layout consists of the size, shape, and position of the electrical connection points 354 and the size, shape, and position of the attachment points 370a, 370b included in the port 258. During use, the second dongle connection port 258 is configured to mirror the layout and capabilities of the accessory port 144 included in the device 104 so that accessories designed for attachment to the accessory port 144 can instead be attached to the second dongle connection port 258 and operate as intended. In the illustrated example, the fourth connection layout is a female mini-GCAI similar to the accessory port 144. However, in other examples, the fourth connection layout may include a male mini-GCAI. In still other examples, the fourth connection layout may include other connection styles such as female GCAI, and male GCAI. In still other examples, other forms of connection layout may be used that are not GCAI or mini-GCAI layouts.

While the illustrated second dongle connection port 258 has the same layout and attempts to duplicate the accessory port 144 of the device 104, in other examples the dongle 100 may also serve as an adapter such that the second dongle connection port 258 provides a different connection layout to accommodate accessories having different connector styles incorporated therein. In such examples, the second dongle connection port 258 would still be configured to convey the necessary signals to the device 104 for operation of the accessory simultaneous to the operation of the dongle 100 itself.

As shown in FIG. 8, the dongle wireless communication assembly 112 includes an antenna 374 and is configured to send and receive wireless signals using at a second wireless communication protocol that is different than the first wireless communication protocol used by the first wireless communications assembly 108. In some examples, the second wireless communication assembly 112 serves as both transmitter and receiver sending and receiving wireless signals using a long-term evolution (LTE) protocol. While the illustrated second wireless communication assembly 112 operates using the LTE protocol, it is understood that in other examples any wireless technology modem or cellular communication protocol may be used. In still other examples, the wireless communication assembly 112 may output signals using more than one wireless communication protocol. In such examples, at least one of the protocols is different than the first wireless communication protocol used by the first wireless communication assembly 108.

In the illustrated example, the dongle wireless communication assembly 112 also includes an LTE module 378, a buck regulator 382, a subscriber identity module (SIM) 386, and memory 390 (e.g., EEPROM). As shown in FIG. 9, the buck regulator 382 receives electrical power via the constant voltage source 176e. The regulated voltage from the buck regulator 382 is then directed to the SIM 386 and LTE module 378.

The dongle wireless communication assembly 112 also includes a switch 388 incorporated into the constant voltage source 176e between the first dongle connection port 254 and the second dongle connection port 258. During operation, the switch 388 is operable in a first or closed configuration, in which the voltage source 176e of the accessory port 144 is passed through to the second dongle connection port 258, and a second or open configuration, in which the voltage source 176e of the accessory port 144 is not passed through to the second dongle connection port 258. In some examples, the switch 388 is placed in the open configuration when no accessory is attached to the second dongle connection port 258 and placed in the closed configuration when an accessory is attached to the second dongle connection port 258. In other examples, the operation of the switch 388 may be based on the operating status of the accessory, the operating status of the dongle wireless communication assembly 112, the type of accessory attached to the second dongle connection port 258, and the like.

In the illustrated example, the antenna 374 of the assembly 112 is coupled to the first end 274 of the body 250 such that the antenna 374 itself extends outwardly therefrom. In some examples, the antenna 374 may include an antenna cap 404 to which the antenna 374 is coupled. In such examples, the cap 404 may be coupled to and at least partially form the first end 274 of the body 250. In some examples, the antenna 374 may be extendable in length. In other examples, the antenna 374 may be fixed. In still other examples, the antenna 374 may be pivotable such that it can extend outwardly from the body 250 in different directions.

When installed, the antenna 374 of the dongle wireless communication assembly 112 is attached to at least one of the first PCB 324 and the second PCB 366 by leads extending through the second channel 312 of the body 250. In some constructions, such leads may include a board-to-board connector. In other constructions, the leads may include individual wires. In still other examples, the antenna 374 may be in conductive communication with the body 250. In such examples, the body 250 is formed from metallic material so that the body 250 may serve as a ground for the antenna 374.

During operation, the dongle 100 is configured to exchange signals with the device 104 via the connection formed between the first dongle connection port 254 and the accessory port 144. As shown in FIG. 9, from the plurality of signals transmitted between the device 104 and the dongle 100, a first signal is transmitted with the second wireless communication assembly 112 while a second signal is passed-through the dongle 100 between the first dongle connection port 254 and the second dongle connection port 258. In some examples, a third signal may be transmitted to interact with both the second wireless communication assembly 112 and the second dongle connection port 258.

In the illustrated example, each signal of the above-described plurality of signals are generally categorized as common signals 408, wireless communication signals 412, or accessory signals 416. Common signals 408 include signals that are applicable to the overall operation of the dongle 100, the wireless communication capabilities of the dongle 100, and/or the operation of any accessories attached to the second dongle connection port 258 (e.g., the constant voltage source 176e, the GPIO signal 176f). Wireless communication signals 412 include signals that are applicable to the operation of the second wireless communication assembly 112 (e.g., the data signals 176d), and accessory signals 416 include signals that are applicable to the operation of any accessories attached to the second dongle connection port 258 (e.g., the remote microphone signal 176a, the remote speaker signal 176b, the remote PTT control signal 176c, and the GPIO signals 176f). In some examples, the wireless communication signals 412 are transmitted between the wireless communication assembly 112 and the first dongle connection port 254. In other examples, the accessory signals 416 are passed through between the first dongle connection port 254 and the second dongle connection port 258.

As shown in FIGS. 1-3, 5, and 9, the device 104 and/or dongle 100 may interact with an accessory or other electrical device. Accessories generally provide some form of additional capability to the device 104, the dongle 100, or both. Each accessory includes a connection port 420 configured to be releasably attached to one of the accessory port 144 or the second dongle connection port 258 and transmit electrical signals therethrough.

The connection port 420 also includes two attachment points 430a, 430b configured to form a corresponding physical connection with the first and second attachment points 200a, 200b of the accessory port 144 or the first and second attachment points 370a, 370b of the second dongle connection port 258. In one example, the first attachment point 430a includes a protrusion or mounting tab configured to be received within the recess of the first attachment point 200a of the accessory port 144 or the first attachment point 370a of the second dongle connection port 258. In other examples, the first attachment point 430a, may include a recess. In still other examples, other forms of connection may be used.

The second attachment point 430b includes a fastener 434. The fastener 434 includes a set of male threads sized to be threadably received within the female threads of the second attachment point 200b of the accessory port 144 or the second attachment point 370b of the second dongle connection port 258. The second attachment point 430b also includes a thumb wheel 438. During use, rotating the thumb wheel 438 causes the male thread the fastener 434 to thread into and form a connection with the female threads of the second attachment point 200b.

As shown in FIG. 5, the connection port 420 includes a fifth connection layout that is compatible with the second connection layout of the accessory port 144 such that the connection port 420 is couplable to the accessory port 144. The connection port 420 is also compatible with the fourth connection layout of the second dongle connection port 258 such that the connection port 420 is couplable to the second dongle connection port 258. The fifth connection layout consists of the size, shape, and position of the electrical connection points and the size, shape, and position of the attachment points 430a, 430b included in the port 420. In some examples, the fifth connection layout forms a male/female pair of the same connection style with both the second connection layout and the fourth connection layout.

In the illustrated example, the fifth connection layout is a male mini-GCAI. However, in other examples, the fifth connection layout may include a female mini-GCAI. In still other examples, the fifth connection layout may include other connection styles such as female GCAI, and male GCAI. In still other examples, other forms of connection layout may be used that are not GCAI or mini-GCAI layouts.

In the illustrated example, the accessory is a RSM 162. The RSM 162 includes a head unit 424 with a remote microphone 204 and speaker 208. The illustrated RSM 162 also includes a remote PTT button 212. Still further, the RSM 162 includes the connection port 420 (described above) that is attached to the head unit 424 via a cable 428. While the illustrated accessory is a RSM 162, it is understood that other types of accessories may be used.

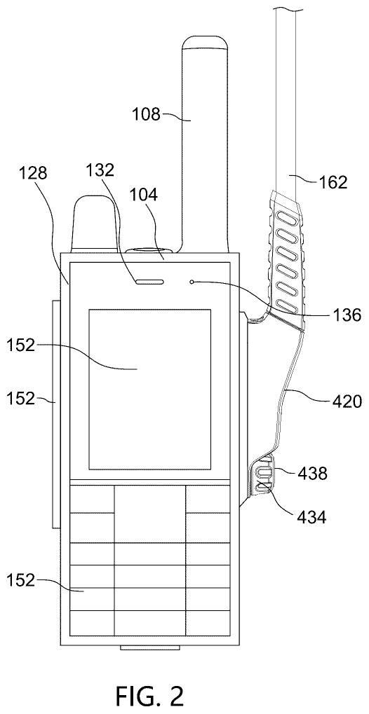

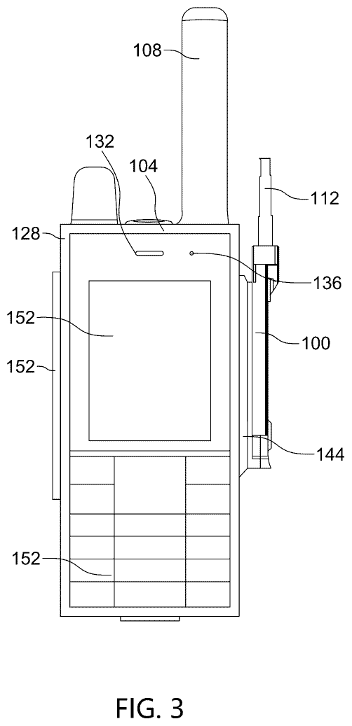

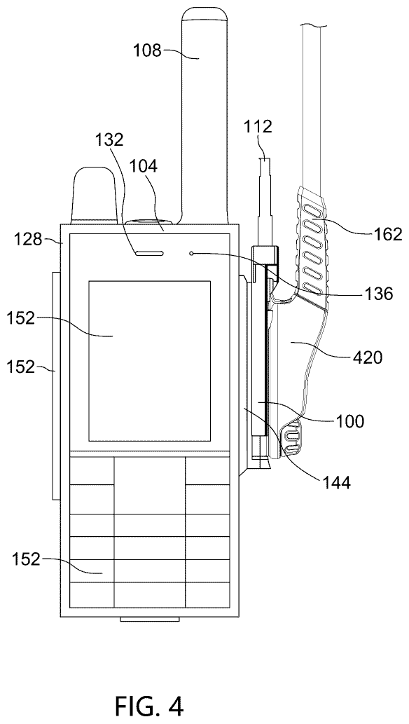

As shown in FIGS. 2-4, the device 104 is operable in a first mode, in which the device 104 does not have any accessories attached to the accessory port 144, a second mode, in which an accessory (e.g., the RSM 162) is coupled to the accessory port 144 (see FIG. 2), a third mode, in which the dongle 100 is coupled to the accessory port 144 (see FIG. 3), and a fourth mode, in which the dongle 100 is coupled to the accessory port 144 and an accessory (e.g., the RSM 162) is attached to the dongle 100 (see FIG. 4).

When operating in the first mode of operation, the device 104 may send and receive wireless signals using the first wireless protocol via the first wireless communication assembly 108 (e.g., via LMR). The device 104 may also send and receive external information (e.g., audio information, user inputs, user outputs, and the like) via the self-contained user interfaces 152, the self-contained microphone 136, and the self-contained speaker 132.

When operating in the second mode of operation, the device 104 may send and receive wireless signals using the first wireless protocol via the first wireless communication assembly 108 (e.g., via LMR). The device 104 may also send and receive external information via the self-contained elements (e.g., any self-contained user interfaces 152, the self-contained microphone 136, and the self-contained speaker 132) or similar elements contained in the attached accessory. In examples where an RSM 162 is attached to the accessory port 144, the device 104 may send and receive external information via the remote speaker 208, remote microphone 204, and remote PTT button 212.

To assemble the device 104 for operation in the second mode of operation, the device 104 and desired accessory (e.g., the RSM 162) are obtained. The accessory is then coupled to the device 104 via the accessory port 144. To do so, the protrusion or first attachment point 430a of the connection port 420 of the accessory is inserted into the recess or first attachment point 200a of the accessory port 144. The connection port 420 can then be pivoted into position until the connection points 354 of the accessory port 144 are in contact with and form electrical connections with the corresponding points on the connection port 420. The connection is then secured by rotating the fastener 434 via the thumb wheel 438 so that the male threads are threaded into and form a connection with the female threads of the second attachment point 200b. The device 104 and accessory may then be operated as described above.

When operating in the third mode of operation, the device 104 may send and receive wireless signals using both the first wireless protocol (e.g., via the first wireless communication assembly 108) and the second wireless protocol (e.g., via the second wireless communication assembly 112). The device 104 may also send and receive external information via the self-contained user interfaces 152, the self-contained microphone 136, and the self-contained speaker 132.

To assemble the device 104 for operation in the third mode of operation. The device 104 and the dongle 100 are obtained. The dongle 100 is then attached to the device 104 via the accessory port 144. To do so, the protrusion or first attachment point 330a of the first dongle connection port 254 is inserted into the recess or first attachment point 200a of the accessory port 144. The dongle 100 is then pivoted into position until the connection points 354 of the accessory port 144 are in contact with and form electrical connections with corresponding connection points 318 of the first dongle connection port 254. The connection is then secured by rotating the fastener 334 via the slots 344 formed in the second end 342 thereof so that the male threads of the first end 338 are threaded into and form a connection with the female threads of the second attachment point 200b. The device 104 and dongle 100 may then be operated as described above.

When operating in the fourth mode of operation, the device 104 may send and receive wireless signals using both the first wireless protocol (e.g., via the first wireless communication assembly 108) and the second wireless protocol (e.g., via the second wireless communication assembly 112). The device 104 may also send and receive external information via the self-contained elements (e.g., the self-contained user interfaces 152, the self-contained microphone 136, and the self-contained speaker 132) or similar elements contained in the accessory attached to the dongle 100. In examples where an RSM 162 is attached to the second dongle connection port 258, the device 104 may send and receive external information via the remote speaker 208, the remote microphone 204, and the remote PTT button 212.

To assemble the device 104 for operation in the fourth mode of operation. The device 104, the dongle 100, and the accessory (e.g., the RSM 162) are obtained. The dongle 100 is then attached to the device 104 via the accessory port 144. To do so, the protrusion or first attachment point 330a of the first dongle connection port 254 is inserted into the recess or first attachment point 200a of the accessory port 144. The dongle 100 is then pivoted into position until the connection points 354 of the accessory port 144 are in contact with and form electrical connections with corresponding connection points 318 of the first dongle connection port 254. The connection is then secured by rotating the fastener 334 via the slots 344 formed in the second end 342 thereof so that the male threads of the first end 338 are threaded into and form a connection with the female threads of the second attachment point 200b of the accessory port 144.

With the dongle 100 attached, the accessory may then be attached to the second dongle connection port 258. To do so, the protrusion or first attachment point 430a of the connection port 420 is inserted into the recess or first attachment point 370a of the second dongle connection port 258. The =connection port 420 is then pivoted into position until the connection points 354 of the second dongle connection port 258 are in contact with and form electrical connections with corresponding connection points on the connection port 420. The connection is then secured by rotating the fastener 434 via the thumb wheel 438 causing the male threads of the fastener 434 to be threaded into and form a connection with the female threads of the second end of the fastener 334 (e.g., the second attachment point 370b). The device 104, the dongle 100, and the accessory may then be operated as described above.

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A dongle for use with an electronic communications device having an accessory port, the dongle comprising:
a body;
a first connection port coupled to the body and configured to establish a first plurality of electrical connections with the accessory port of the electronic communications device;
a second connection port coupled to the body and configured to establish a second plurality of electrical connections with another electrical device; and
a wireless communication assembly, wherein the wireless communication assembly is configured to receive a first signal from the second connection port and generate wireless signals, and
wherein the dongle is configured to pass through a second signal between the first connection port and the second connection port.

2. The dongle of claim 1, wherein the first connection port includes a plurality of pogo pins.

3. The dongle of claim 1, wherein the first connection port includes a first printed circuit board (PCB), wherein the second connection port includes a second PCB, and wherein the first PCB is coupled to the second PCB.

4. The dongle of claim 1, further comprising a fastener, wherein the fastener includes a first end configured to couple with a first style of connection, and wherein the fastener includes a second end configured to form the first style of connection.

5. The dongle of claim 4, wherein the first end of the fastener forms male threads, and the second end of the fastener forms female threads, and wherein the male threads and the female threads are co-axial.

6. The dongle of claim 1, wherein the wireless communication assembly includes an antenna.

7. The dongle of claim 1, wherein the wireless communication assembly is configured to generate wireless signals in accordance with any wireless technology modem.

8. The dongle of claim 1, wherein the second signal includes a signal selected from the group consisting of a remote speaker signal, and remote microphone signal, and GPIO signals.

9. A dongle for use with an electronic communications device having a first connection port, the dongle comprising:
a body defining a first pocket and a second pocket, and wherein the first pocket is open to the second pocket via a first channel;
a first printed circuit board (PCB) positioned within the first pocket, wherein the first PCB includes a first plurality of connection points configured to establish electrical connections with the first connection port of the electronic communications device;
a second PCB positioned within the second pocket, wherein the second PCB includes a second plurality of connection points configured to establish electrical connections with another electrical device, and wherein the second PCB is coupled to the first PCB via the first channel;
a wireless communications assembly in operable communication with at least one of the first PCB and the second PCB; and
an antenna coupled to the body proximate one end thereof, wherein the antenna is connected to one of the first PCB and the second PCB via an electrical connection extending through a second channel defined by the body.

10. The dongle of claim 9, wherein the second channel is perpendicular to the first channel.

11. The dongle of claim 9, wherein the first pocket is open in a first direction and the second pocket is open in a second direction, and wherein the first direction is parallel to and opposite the second direction.

12. The dongle of claim 9, wherein the body defines a reference plane extending therethrough, and wherein the first pocket and the second pocket are completely positioned on opposite sides of the reference plane.

13. The dongle of claim 9, wherein the first plurality of connection points include pogo pins.

14. A portable communication system comprising:
a wireless communication device including:
a first connection port with a power supply connection,
a second connection port without a power supply connection, and
a first wireless communication assembly;
a dongle including:
a third connection port configured to connect to the second connection port of the wireless communication device,
a fourth connection port, and
a second wireless communication assembly receiving a first signal via the third connection port, and wherein a second signal is passed through between the third connection port and the fourth connection port; and
an accessory having a fifth connection port configured to attach to either the second connection port of the wireless communication device or the fourth connection port of the dongle.

15. The portable communication system of claim 14, wherein the accessory is a remote speaker microphone.

16. The portable communication system of claim 14, wherein the first wireless communication assembly is configured to output wireless signals using a first wireless protocol, and wherein the second wireless communication assembly is configured to output wireless signals using a second wireless protocol that is different than the first wireless protocol.

17. The portable communication system of claim 14, wherein the fourth connection port has the same connection layout as the second connection port.

18. The portable communication system of claim 17, wherein both the fourth connection port and the second connection port are mini-GCAI connections.

19. The portable communication system of claim 14, wherein the dongle includes a fastener, and wherein a first end of the fastener is configured to interact with the second connection port, and wherein a second end of the fastener is configured to interact with the fifth connection port.

20. The portable communication system of claim 19, wherein the first end forms male threads and wherein the second end forms female threads.
